(19) United States
(12) Patent Application Publication
(10) Pub. No.: US 2024/0337548 A1
(43) Pub. Date: Oct. 10, 2024

(54) SYSTEMS AND METHODS FOR TORQUE SENSOR HYSTERESIS COMPENSATION

(71) Applicant: STEERING SOLUTIONS IP HOLDING CORPORATION, Saginaw, MI (US)

(72) Inventor: Joel E. Birsching, Vassar, MI (US)

(21) Appl. No.: 18/627,951

(22) Filed: Apr. 5, 2024

Related U.S. Application Data
(60) Provisional application No. 63/457,910, filed on Apr. 7, 2023.

(51) Int. Cl. G01L 5/00; B62D 5/04

(52) U.S. Cl. CPC G01L 5/0066; B62D 5/0463

(57) ABSTRACT

A method for compensating for torque sensor hysteresis. The method includes receiving, from a torque sensor, a first torque signal corresponding to a torque applied to a handwheel associated with a steering system; determining a full hysteresis value associated with the torque sensor; determining a shift value based on the full hysteresis value; calculating a product of the full hysteresis value and the shift value; generating a modified torque signal based on the first torque signal and the product of the full hysteresis value and the shift value; and determining a torque assist value based on the modified torque signal.

### CROSS-REFERENCES TO RELATED APPLICATIONS

This patent application claims priority to U.S. Provisional Patent Application Ser. No. 63/457,910, filed Apr. 7, 2023 which is incorporated herein by reference in its entirety.

### TECHNICAL FIELD

This disclosure relates to vehicle steering systems and in particular to systems and methods for torque sensor hysteresis compensation in vehicle steering systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system.

The steering system of such a vehicle typically controls various aspects of vehicle steering including providing steering assist to an operator of the vehicle, controlling steerable wheels of the vehicle, and the like. Additionally, such a steering system typically uses a torque sensor to sense the driver torque input into the steering system in order to determine the amount of assist torque that is required for the given steering maneuver.

### SUMMARY OF THE INVENTION

This disclosure relates generally to vehicle steering systems.

An aspect of the disclosed embodiments includes a method for compensating for torque sensor hysteresis. The method includes receiving, from a torque sensor, a first torque signal corresponding to a torque applied to a handwheel associated with a steering system; determining a full hysteresis value associated with the torque sensor; determining a shift value based on the full hysteresis value; calculating a product of the full hysteresis value and the shift value; generating a modified torque signal based on the first torque signal and the product of the full hysteresis value and the shift value; and determining a torque assist value based on the modified torque signal.

Another aspect of the disclosed embodiments includes a system for compensating for torque sensor hysteresis. The system includes a processor and a memory. The memory includes instructions that, when executed by the processor, cause the processor to: receive, from a torque sensor, a first torque signal corresponding to a torque applied to a handwheel associated with a steering system; determine a full hysteresis value associated with the torque sensor; determine a shift value based on the full hysteresis value; calculate a product of the full hysteresis value and the shift value; generate a modified torque signal based on the first torque signal and the product of the full hysteresis value and the shift value; and determine a torque assist value based on the modified torque signal.

Another aspect of the disclosed embodiments includes an apparatus for compensating for signal hysteresis. The apparatus includes a controller configured to: receive a first signal from a sensor; determine a full hysteresis value associated with the sensor; determine a shift value based on the full hysteresis value; calculate a product of the full hysteresis value and the shift value; generate a modified signal by subtracting the product of the full hysteresis value and the shift value from the first signal; determine a control value based on the modified signal; and apply the control value to at least one actuator.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIG. 3 generally illustrates a torque sensor according to the principles of the present disclosure.

FIG. 4 generally illustrates a block diagram of a torque sensor hysteresis compensation system according to the principles of the present disclosure.

FIG. 5 generally illustrates a right corner block according to the principles of the present disclosure.

FIG. 6 generally illustrates a block diagram of a left corner block according to the principles of the present disclosure.

FIG. 7 generally illustrates a block diagram of a none block according to the principles of the present disclosure

FIG. 8 is a flow diagram generally illustrating a torque sensor hysteresis compensation method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an (EPS) system, an SbW steering system, a hydraulic steering system, or other suitable steering system.

The steering system of such a vehicle typically controls various aspects of vehicle steering including providing steering assist to an operator of the vehicle, controlling steerable wheels of the vehicle, and the like. Additionally, such a steering system typically uses a torque sensor to sense the driver torque input into the steering system in order to determine the amount of assist torque that is required for the given steering maneuver.

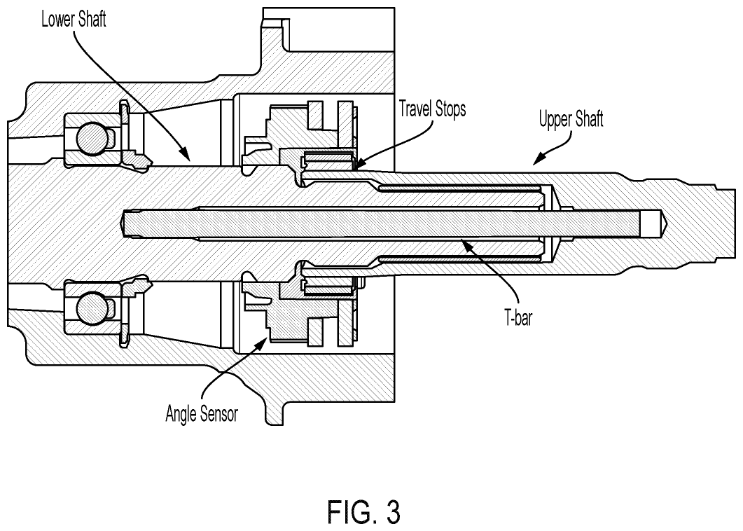

A cross section of such a torque sensor is generally illustrated in FIG. 3. The torque sensor may include an upper shaft, which is operably connected to a steering wheel (e.g., which may be referred to herein as a handwheel) of the vehicle, and a lower shaft, which is connected to a pinion, which meshes with a rack that turns steerable wheels of the vehicle. A set of travel stops are incorporated into the upper and lower shafts to limit the relative rotation between the two shafts to a value approximately +/−5 degrees. A torsion bar is connected to the upper shaft at one end, and to the lower shaft at the other end, such that when there is no torque on the assembly, the upper and lower shafts are centered within the travel stops. An angle sensor is attached to the upper and lower shafts to sense the angle of rotation between the two shafts.

When the driver of the vehicle applies torque to the assembly, the torsion bar deflects, and there is a relative angular rotation between the upper and lower shafts. The angular rotation is measured by the angle sensor, and the measured angle can be multiplied by the torsional rate of the torsion bar to determine the torque that is input by the driver.

There are some lower cost methods of manufacturing the assembly and some angle sensing technologies that have hysteresis in the torque signal. When torque is applied to the sensor and then released, the sensor signal does not come back to zero. A torque may be applied in the opposite direction for the signal to return to zero. This results in an error in the torque signal that can lead to poor steering feel and leads and pulls conditions in the vehicle if these lower cost designs are used.

Accordingly, systems and methods, such as those described herein, configured to provide torque sensor hysteresis compensation, may be desirable. In some embodiments, the systems and methods described herein may be configured to provide torque sensor hysteresis compensation. The systems and methods described herein may be configured to modify the torque sensor signal to remove the effects of the hysteresis.

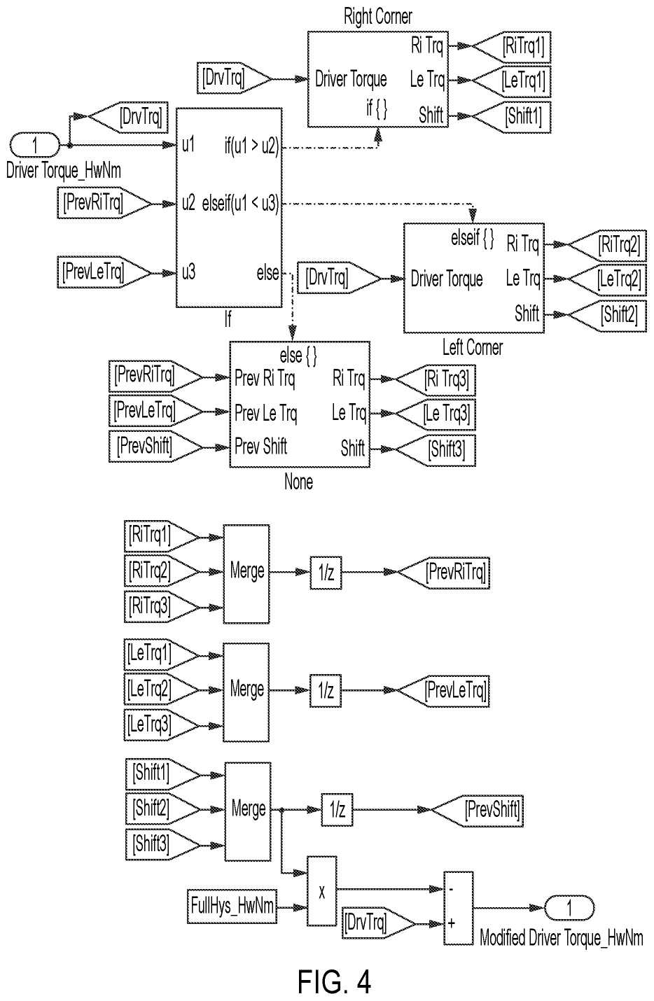

FIG. 4 generally illustrates a torque sensor hysteresis compensation system block diagram, according to the principles of the present disclosure. The systems and methods described herein may be configured to receive an incoming torque signal and modify the torque signal by subtracting the product of a shift value and a full hysteresis value. The systems and methods described herein may be configured to determine the full hysteresis value using the difference between the torque signal when the sensor is actuated to the full right torque sensor stop and returned to 0 torque, and the torque signal when the sensor is actuated to the full left torque sensor stop and returned to 0 torque. This full hysteresis value may be a calibration, a learned value, or a value measured during the manufacturing process.

The shift value may include a value between 0.5 and −0.5, which may represent an operating point within the hysteresis band. The systems and methods described herein may be configured to determine the shift value based on a magnitude of the torque signal compared to a stored previous right torque value and a stored previous left torque value. If the torque signal is greater than the previous right torque value, the systems and methods described herein may be configured to update the shift value and the previous right and left torque values are based on the right corner block. If the signal is less than the previous left torque value, the systems and methods described herein may be configured to update the shift value and the previous right and left torque values based on the left corner block. If the torque signal is between the previous right and left torque values, the systems and methods described herein may be configured to update the shift value and the previous right and left torque values based on the none block.

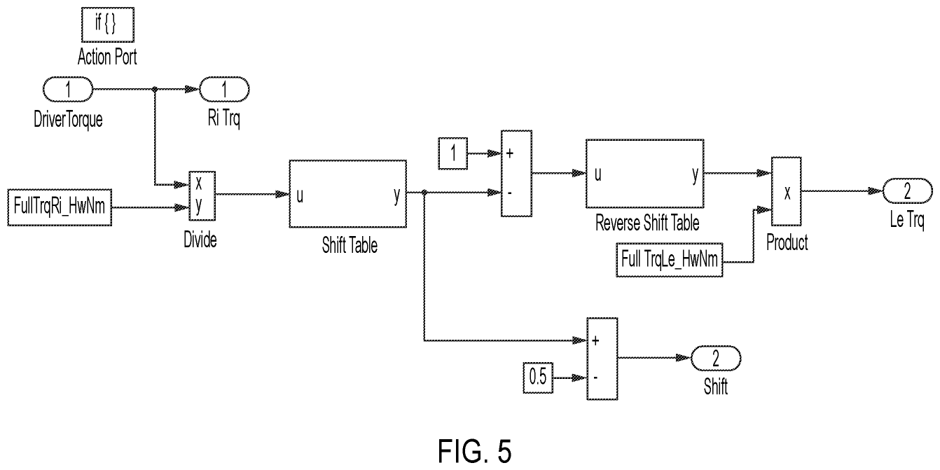

FIG. 5 generally illustrates a block diagram of the right corner block, according to the principles of the present disclosure. The systems and methods described herein may be configured to set the previous right torque value for the next iteration equal to the torque signal of the current iteration. The systems and methods described herein may be configured to divide the torque signal by a full right torque value, which may include a value representing the full torque required to actuate the torque sensor to the right travel stop. The full right torque value may be a calibratable value, or a value measured during the manufacturing process. The quotient is used as an input to a lookup table. The output of the lookup table is a value between zero and one representing the operating point within the hysteresis loop.

A value of 0.5 is subtracted from the output of the lookup table to determine the Shift value that ranges between 0.5 and −0.5. A second value is also determined from the output of the lookup table by subtracting the output from a value of 1. This value is input into a second lookup table. The second lookup table is the same as the first lookup table with the X and Y values switched. The output of the second lookup table is a value between zero and one. The output of the second lookup table is multiplied by a full left torque value. The full left torque value may include a value representing the full torque required to actuate the torque sensor to the left travel stop. The full left torque value may be a calibratable value, or a value measured during the manufacturing process. The product of the output of the second lookup table and the full Left torque value may be saved as the previous left torque value for the next iteration.

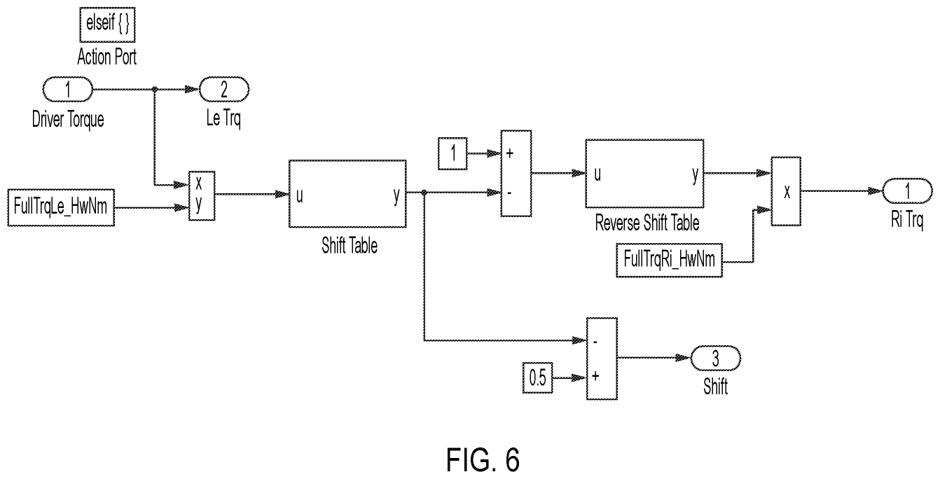

FIG. 6 generally illustrates a block diagram of the left corner block, according to the principles of the present disclosure. The systems and methods described herein may be configured to set the previous left torque value for the next iteration equal to the torque signal of the current iteration. The systems and methods described herein may be configured to divide the torque signal by the full left torque value. The full left torque value may include the same value used in the right corner block. The quotient is used as an input to a lookup table. The lookup table has the same X and Y values as the lookup table in the right corner block. The output of the lookup table may include a value between zero and one representing the operating point within the hysteresis loop. The output of the lookup table is subtracted from a value of 0.5 to determine the shift value that ranges between 0.5 and −0.5. A second value is also determined from the output of the lookup table by subtracting the output from a value of 1. This value is input into a second lookup table. The second lookup table is the same as the first lookup table with the X and Y values switched. The output of the second lookup table is a value between zero and one. The output of the second lookup table is multiplied by the full right torque value. The full right torque value has the same value used in the right corner block. The product of the output of the second lookup table and the full right torque value may be saved as the previous right torque value for the next iteration.

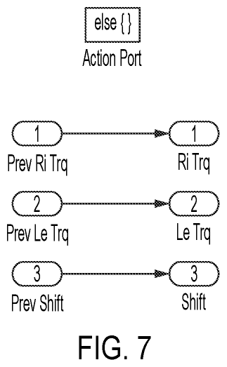

FIG. 7 generally illustrates a block diagram of the none block, according to the principles of the present disclosure. The systems and methods described herein may be configured to execute the none block, which, when executed, causes the values for the previous right torque, the previous left torque, and the shift value to be the same as the values from the previous loop.

In some embodiments, the systems and methods described herein may be configured to provide compensation for torque sensor hysteresis. The systems and methods described herein may be configured to use at least some lower cost methods of manufacturing the assembly and some angle sensing technologies that have hysteresis in the torque signal. The systems and methods described herein may be configured to, by modifying the torque signal produced by these designs, reduce the error in the torque signal, leading to improved steering feel and reduced leads and pulls conditions in the vehicle.

In some embodiments, the systems and methods described herein may be configured to receive, from a torque sensor, a first torque signal corresponding to a torque applied to a handwheel associated with a steering system. The systems and methods described herein may be configured to determine a full hysteresis value associated with the torque sensor. For example, the systems and methods described herein may be configured to determine the full hysteresis value based on a difference between second torque signal and a third torque signal. The second torque signal may correspond to the torque sensor being actuated to a full right torque sensor stop and returned to 0 torque, and the third torque signal may correspond to the torque sensor being actuated to a full left torque sensor stop and returned to 0 torque.

The systems and methods described herein may be configured to determine a shift value based on the full hysteresis value. For example, the systems and methods described herein may be configured to determine the shift value based on the full hysteresis value by comparing the first torque signal to a stored previous right torque value and a store previous left torque value.

The systems and methods described herein may be configured to calculate a product of the full hysteresis value and the shift value. The systems and methods described herein may be configured to generate a modified torque signal based on the first torque signal and the product of the full hysteresis value and the shift value. The systems and methods described herein may be configured to determine a torque assist value based on the modified torque signal. For example, the systems and methods described herein may be configured to generate the modified torque signal based on the first torque signal and the product of the full hysteresis value and the shift value by subtracting the product of the full hysteresis value and the shift value from the first torque signal.

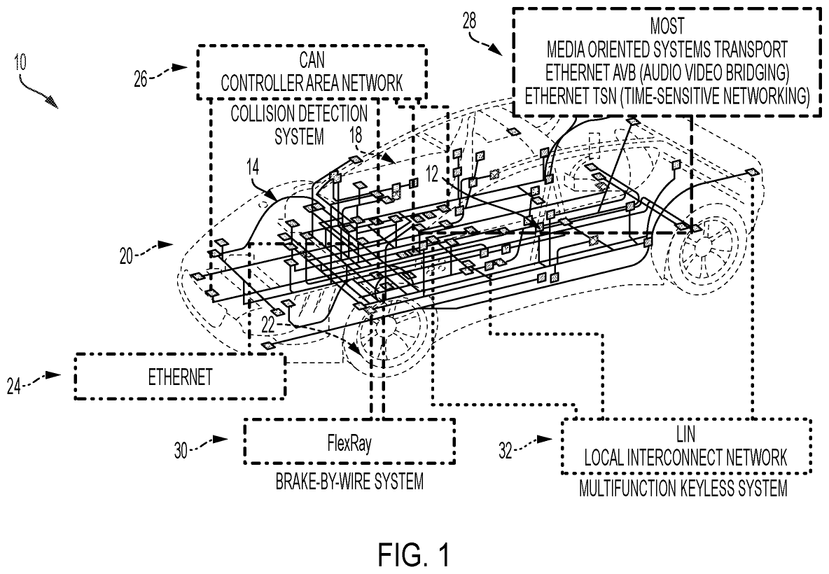

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

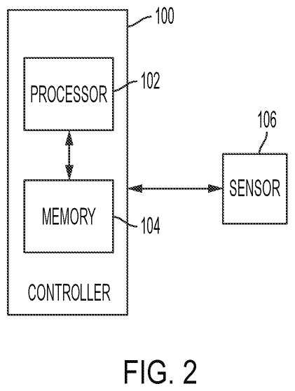

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

In some embodiments, controller 100 may be configured to provide torque sensor hysteresis compensation for the sensor 106. For example, the controller 100 may receive, from the sensor 106, a first torque signal corresponding to a torque applied to the handwheel associated with the steering system of the vehicle 10. The sensor 106, as described, may include a torque sensor and may include characteristics similar to the torque sensor of FIG. 3 or any other suitable characteristics in addition to or instead of those of the torque sensor of FIG. 3. The controller 100 may determine a full hysteresis value associated with the sensor 106. For example, the controller 100 may determine the full hysteresis value based on a difference between second torque signal and a third torque signal. The second torque signal may correspond to the sensor sen 106 being actuated to a full right torque sensor stop and returned to 0 torque, and the third torque signal may correspond to the sensor 106 being actuated to a full left torque sensor stop and returned to 0 torque.

The controller 100 may determine a shift value based on the full hysteresis value. For example, the controller 100 may determine the shift value based on the full hysteresis value by comparing the first torque signal to a stored previous right torque value and a store previous left torque value.

The controller 100 may calculate a product of the full hysteresis value and the shift value. The controller 100 may generate a modified torque signal based on the first torque signal and the product of the full hysteresis value and the shift value. The controller 100 may determine a torque assist value based on the modified torque signal. For example, the controller 100 may generate the modified torque signal based on the first torque signal and the product of the full hysteresis value and the shift value by subtracting the product of the full hysteresis value and the shift value from the first torque signal. The torque assist value may be applied to the steering system to provide torque assist to the driver of the vehicle 10 while performing a steering maneuver.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

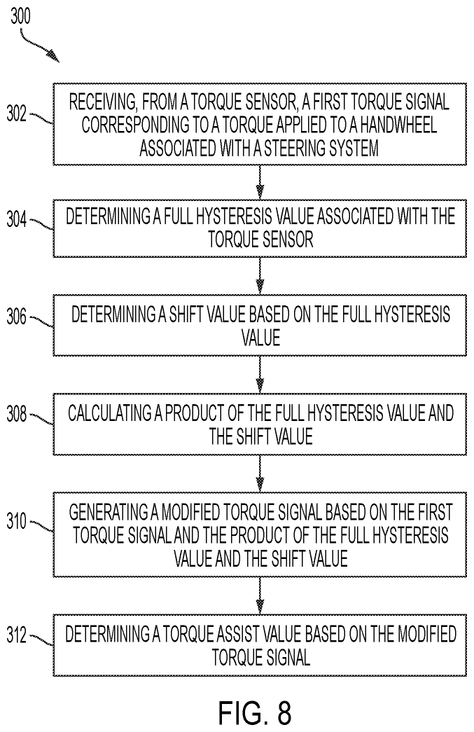

FIG. 8 is a flow diagram generally illustrating a cooperative vehicle operation control method 300, according to the principles of the present disclosure. At 302, the method 300 receives, from a torque sensor, a first torque signal corresponding to a torque applied to a handwheel associated with a steering system. For example, the controller 100 may receive, from the sensor 106, the first torque signal corresponding to the torque applied to the handwheel associated with the steering system of the vehicle 10.

At 304, the method 300 determines a full hysteresis value associated with the torque sensor. For example, the controller 100 may determine the full hysteresis value associated with the sensor 106.

At 306, the method 300 determines a shift value based on the full hysteresis value. For example, the controller 100 may determine the shift value based on the full hysteresis value.

At 308, the method 300 calculates a product of the full hysteresis value and the shift value. For example, the controller 100 may calculate the product of the full hysteresis value and the shift value.

At 310, the method 300 generates a modified torque signal based on the first torque signal and the product of the full hysteresis value and the shift value. For example, the controller 100 may generate the modified torque signal based on the first torque signal and the product of the full hysteresis value and the shift value.

At 312, the method 300 determines a torque assist value based on the modified torque signal. For example, the controller 100 may determine the torque assist value based on the modified torque signal.

In some embodiments, a method for compensating for torque sensor hysteresis includes receiving, from a torque sensor, a first torque signal corresponding to a torque applied to a handwheel associated with a steering system; determining a full hysteresis value associated with the torque sensor; determining a shift value based on the full hysteresis value; calculating a product of the full hysteresis value and the shift value; generating a modified torque signal based on the first torque signal and the product of the full hysteresis value and the shift value; and determining a torque assist value based on the modified torque signal.

In some embodiments, determining the full hysteresis value associated with the torque sensor includes determining a difference between second torque signal and a third torque signal. In some embodiments, the second torque signal corresponds to the torque sensor being actuated to a full right torque sensor stop and returned to 0 torque, and the third torque signal corresponds to the torque sensor being actuated to a full left torque sensor stop and returned to 0 torque. In some embodiments, determining the shift value based on the full hysteresis value includes comparing the first torque signal to a stored previous right torque value and a store previous left torque value. In some embodiments, generating the modified torque signal based on the first torque signal and the product of the full hysteresis value and the shift value includes subtracting the product of the full hysteresis value and the shift value from the first torque signal.

In some embodiments, a system for compensating for torque sensor hysteresis includes a processor and a memory. The memory includes instructions that, when executed by the processor, cause the processor to: receive, from a torque sensor, a first torque signal corresponding to a torque applied to a handwheel associated with a steering system; determine a full hysteresis value associated with the torque sensor; determine a shift value based on the full hysteresis value; calculate a product of the full hysteresis value and the shift value; generate a modified torque signal based on the first torque signal and the product of the full hysteresis value and the shift value; and determine a torque assist value based on the modified torque signal.

In some embodiments, the instructions further cause the processor to determine the full hysteresis value associated with the torque sensor includes by determining a difference between second torque signal and a third torque signal. In some embodiments, the second torque signal corresponds to the torque sensor being actuated to a full right torque sensor stop and returned to 0 torque, and the third torque signal corresponds to the torque sensor being actuated to a full left torque sensor stop and returned to 0 torque. In some embodiments, the instructions further cause the processor to determine the shift value based on the full hysteresis value by comparing the first torque signal to a stored previous right torque value and a store previous left torque value. In some embodiments, the instructions further cause the processor to generate the modified torque signal based on the first torque signal and the product of the full hysteresis value and the shift value by subtracting the product of the full hysteresis value and the shift value from the first torque signal.

In some embodiments, a method for compensating for torque sensor hysteresis includes: receiving, from a torque sensor, a first torque signal corresponding to a torque applied to a handwheel associated with a steering system; determining a full hysteresis value associated with the torque sensor; determining a shift value based on the full hysteresis value; calculating a product of the full hysteresis value and the shift value; generating a modified torque signal based on the first torque signal and the product of the full hysteresis value and the shift value; and determining a torque assist value based on the modified torque signal.

In some embodiments, determining the full hysteresis value includes determining a difference between a second torque signal and a third torque signal. In some embodiments, the second torque signal corresponds to the torque sensor being actuated to a full right torque sensor stop and returned to 0 torque. In some embodiments, the third torque signal corresponds to the torque sensor being actuated to a full left torque sensor stop and returned to 0 torque. In some embodiments, determining the full hysteresis value includes identifying a corresponding stored calibrated value. In some embodiments, determining the full hysteresis value includes identifying a corresponding stored learned value. In some embodiments, determining the full hysteresis value includes identifying a corresponding stored measured value. In some embodiments, the measured value is measured during a manufacturing process. In some embodiments, determining the shift value based on the full hysteresis value includes comparing the first torque signal to a stored previous right torque value and a store previous left torque value. In some embodiments, generating the modified torque signal based on the first torque signal and the product of the full hysteresis value and the shift value includes subtracting the product of the full hysteresis value and the shift value from the first torque signal. In some embodiments, the shift value includes a value between −0.5 and 0.5.

In some embodiments, a system for compensating for torque sensor hysteresis includes: a processor; and a memory including instructions that, when executed by the processor, cause the processor to: receive, from a torque sensor, a first torque signal corresponding to a torque applied to a handwheel associated with a steering system; determine a full hysteresis value associated with the torque sensor; determine a shift value based on the full hysteresis value; calculate a product of the full hysteresis value and the shift value; generate a modified torque signal based on the first torque signal and the product of the full hysteresis value and the shift value; and determine a torque assist value based on the modified torque signal.

In some embodiments, the instructions further cause the processor to determine the full hysteresis value by determining a difference between a second torque signal and a third torque signal. In some embodiments, the second torque signal corresponds to the torque sensor being actuated to a full right torque sensor stop and returned to 0 torque. In some embodiments, the third torque signal corresponds to the torque sensor being actuated to a full left torque sensor stop and returned to 0 torque. In some embodiments, the instructions further cause the processor to determine the full hysteresis value by identifying a corresponding stored calibrated value. In some embodiments, the instructions further cause the processor to determine the full hysteresis value includes by a corresponding stored learned value. In some embodiments, the instructions further cause the processor to determine the full hysteresis value by identifying a corresponding stored measured value. In some embodiments, the measured value is measured during a manufacturing process.

In some embodiments, an apparatus for compensating for signal hysteresis includes a controller configured to: receive a first signal from a sensor; determine a full hysteresis value associated with the sensor; determine a shift value based on the full hysteresis value; calculate a product of the full hysteresis value and the shift value; generate a modified signal by subtracting the product of the full hysteresis value and the shift value from the first signal; determine a control value based on the modified signal; and apply the control value to at least one actuator.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for compensating for torque sensor hysteresis, the method comprising:
receiving, from a torque sensor, a first torque signal corresponding to a torque applied to a handwheel associated with a steering system;
determining a full hysteresis value associated with the torque sensor;
determining a shift value based on the full hysteresis value;
calculating a product of the full hysteresis value and the shift value;
generating a modified torque signal based on the first torque signal and the product of the full hysteresis value and the shift value; and
determining a torque assist value based on the modified torque signal.

2. The method of claim 1, wherein determining the full hysteresis value includes determining a difference between a second torque signal and a third torque signal.

3. The method of claim 2, wherein the second torque signal corresponds to the torque sensor being actuated to a full right torque sensor stop and returned to 0 torque.

4. The method of claim 2, wherein the third torque signal corresponds to the torque sensor being actuated to a full left torque sensor stop and returned to 0 torque.

5. The method of claim 1, wherein determining the full hysteresis value includes identifying a corresponding stored calibrated value.

6. The method of claim 1, wherein determining the full hysteresis value includes identifying a corresponding stored learned value.

7. The method of claim 1, wherein determining the full hysteresis value includes identifying a corresponding stored measured value.

8. The method of claim 7, wherein the measured value is measured during a manufacturing process.

9. The method of claim 1, wherein determining the shift value based on the full hysteresis value includes comparing the first torque signal to a stored previous right torque value and a store previous left torque value.

10. The method of claim 1, wherein generating the modified torque signal based on the first torque signal and the product of the full hysteresis value and the shift value includes subtracting the product of the full hysteresis value and the shift value from the first torque signal.

11. The method of claim 1, wherein the shift value includes a value between −0.5 and 0.5.

12. A system for compensating for torque sensor hysteresis, the system comprising:
a processor; and
a memory including instructions that, when executed by the processor, cause the processor to:
receive, from a torque sensor, a first torque signal corresponding to a torque applied to a handwheel associated with a steering system;
determine a full hysteresis value associated with the torque sensor;
determine a shift value based on the full hysteresis value;
calculate a product of the full hysteresis value and the shift value;
generate a modified torque signal based on the first torque signal and the product of the full hysteresis value and the shift value; and
determine a torque assist value based on the modified torque signal.

13. The system of claim 12, wherein the instructions further cause the processor to determine the full hysteresis value by determining a difference between a second torque signal and a third torque signal.

14. The system of claim 13, wherein the second torque signal corresponds to the torque sensor being actuated to a full right torque sensor stop and returned to 0 torque.

15. The system of claim 13, wherein the third torque signal corresponds to the torque sensor being actuated to a full left torque sensor stop and returned to 0 torque.

16. The system of claim 12, wherein the instructions further cause the processor to determine the full hysteresis value by identifying a corresponding stored calibrated value.

17. The system of claim 12, wherein the instructions further cause the processor to determine the full hysteresis value includes by a corresponding stored learned value.

18. The system of claim 12, wherein the instructions further cause the processor to determine the full hysteresis value by identifying a corresponding stored measured value.

19. The system of claim 18, wherein the measured value is measured during a manufacturing process.

20. An apparatus for compensating for signal hysteresis, the apparatus comprising:
a controller configured to:
receive a first signal from a sensor;
determine a full hysteresis value associated with the sensor;
determine a shift value based on the full hysteresis value;
calculate a product of the full hysteresis value and the shift value;
generate a modified signal by subtracting the product of the full hysteresis value and the shift value from the first signal;
determine a control value based on the modified signal; and
apply the control value to at least one actuator.
